(19) United States
(12) Patent Application Publication
(10) Pub. No.: US 2003/0099586 A1
(43) Pub. Date: May 29, 2003

(54) Conversion of CO TO CO2

(75) Inventors: Joseph Pugach, Monroeville, PA (US); Thomas E. Hewitt III, Sewickley, PA (US)

Correspondence Address: William L. Krayer, 1771 Helen Drive, Pittsburgh, PA, 15216, US

(73) Assignee: Pressure Chemical Co.

(21) Appl. No.: 09/997,617

(22) Filed: Nov. 29, 2001

(51) Int. Cl. B01D 53/62

(52) U.S. Cl. 423/247

(57) ABSTRACT

Gold oxide is precipitated together with iron oxide from a solution containing a gold source and an iron source; the gel formed thereby is washed, dried, ground to a size range of 0.85 mm to 4.25 mm and calcined; then used as a catalyst for oxidizing CO to CO₂ in the presence of a large excess of hydrogen.

### TECHNICAL FIELD

A catalyst containing both gold and iron is used in oxidation processes. It is especially useful for the oxidation of carbon monoxide to carbon dioxide, particularly in the presence of a large excess of hydrogen.

### BACKGROUND OF THE INVENTION

Many workers in the art of catalysis have centered their attention on efforts to create gold catalysts of a fine size effective to catalyze the oxidation of carbon monoxide to carbon dioxide, particularly in the presence of a large excess of hydrogen and in mixtures of gases wherein the carbon monoxide is a small percentage. The fine size thought to be beneficial for providing a large contact surface for the reactants. See, for example, Haruta et al U.S. Pat. Nos. 4,839,327 and 5,506,273. Some workers deposit and therefore spread out their catalyst compositions on porous supports, such as described by Grigorova et al in U.S. Pat. Nos. 5,665,668 and 5,759,949; Haruta et al, in U.S. Pat. No. 4,939,219, propose placing the gold on an alkaline earth metal support.

In German patent DE 198 36 585 C1, Plzak first states that it is desirable for the catalyst materials of his invention to have specific surface areas as high as possible and then describes three variations of his preparation of gold-containing catalysts for CO oxidation. In the first, the material is produced sequentially—that is, an iron salt is first reacted with a base to form an iron hydroxide gel, then the gel is impregnated with a solution of a gold compound, to “deposit complexed Au clusters on the surface of the hydroxide gel in the finest distribution” (um komplexierte Au-Cluster auf der Oberfläche des Hydroxidgels in feinster Verteilung abzuscheiden—p3, line 44. The authors go on to say that much smaller Au clusters can be fixed on the Fe₂O₃ support material by the sequential process than by a coprecipitation process. The sequential process is therefore considered to be superior to the coprecipitation process, but Plzak does not recognize the disadvantages of using a powder in the CO oxidizing step.

In Plzak's second stated process, a sinter inhibitor which is an oxide of aluminum, chromium, or magnesium is created during the first step of iron precipitation by including with the reactants a water soluble salt of Al, Cr or Mg. A third variation calls for the inclusion of the Al, Cr or Mg salt along with all the other reactants in the coprecipitation procedure. The sequential process is still considered by Plzak to be superior.

The reader may be interested in Haruta et al's Example 1 of U.S. Pat. No. 5,506,273 which prepares a catalyst containing a metal oxide and gold, said to be useful for oxidation of carbon monoxide.

The art is in need of a convenient process for oxidizing CO in a mixture including a high level of hydrogen with an acceptable pressure drop.

### SUMMARY OF THE INVENTION

My invention provides a simplified procedure for making a gold catalyst which is convenient to use; the gold catalyst does not require a separate solid or porous support and is highly efficient for the oxidation of carbon monoxide in mixed gases, particularly in mixed gases containing a large excess of hydrogen.

My catalyst is made using solutions of materials, yet a hard, highly efficient catalyst results. Gold oxide is precipitated from a solution of a gold source in the presence of an iron source in solution while controlling the pH of the solution preferably at 7.8 to 8.2, thereby causing the formation of a gold oxide precipitate either onto or intimately mixed with an iron oxide precipitate, separating the precipitate combination from the solution, washing it, drying it, grinding it, and only then calcining it. The iron compound solution may be made separately, or the iron and gold sources may be combined in a single solution and a separate solution added slowly to maintain the desired pH during the precipitation process. Preferably the precipitation is brought about by adding both the iron and gold source solutions gradually to neutral water together with the gradual addition of a solution of the pH-maintaining base.

The gold source may be any gold salt or compound which will yield gold oxide from solution in the presence of a base. Examples of such gold sources are gold (III) chloride, iodide and bromide, gold (III) nitrate, hydrogen tetrahaloaurates and their alkali metal salts where the halogen is other than fluoride, and hydrogen nitroaurate.

As the iron source, any iron compound capable of forming Fe₂O₃ in a basic aqueous solution may be used. Water-soluble iron salts are preferred. Iron nitrate is preferred as the iron source, as its extraneous components, i.e. the nitrogen, will bum off with little contamination or other problems during calcination, whereas materials such as iron sulfate and ferric chloride would require much more washing and other treatment to prepare the catalyst for commercial use.

Suitable alkali metal bases which may be used are alkali metal carbonates, bicarbonates and hydroxides.

Persons skilled in the art will recognize that the pH is maintained during the precipitation of the iron and gold. If the pH is allowed to drift outside the ranges specified (preferably 7-9), one undesirable result will be that the particle size of the precipitate will be adversely affected. A pH range of 7.5 to 8.5 is preferred; more preferably, the solutions are maintained at pH 7.8-8.2 during the precipitation process.

Persons skilled in the art may appreciate that the iron precipitate will comprise Fe₂O₃ in an aqueous network. The iron oxide will tend to polymerize, and is de-oxidized during calcination, so that the final product is a gold metal deposit on an iron oxide (Fe₃O₄) support.

Gold should be present in the final product as 0.25 to 10% by weight of the iron oxide. Higher amounts of gold may be used but are not necessary for the efficient function of the catalyst in the oxidation of carbon monoxide to carbon dioxide in the presence of an excess of hydrogen. A preferred range of gold content for that purpose is 1-3%.

After the combined precipitate (sometimes herein referred to as solids) is separated from the suspension or solution, it is washed, dried, ground and then calcined. The desired particulate range may be achieved by any known procedure of grinding, screening and the like. For use in oxidizing carbon monoxide to carbon dioxide in a gas stream including hydrogen and oxygen, a size range of 0.85 mm to 3.25 mm is preferred; a range of 1 mm to 1.4 mm is more preferable.

### DETAILED DESCRIPTION OF THE INVENTION

Following are examples of the invention.

### INVENTION EXAMPLE 1

### Co-Precipitation

A solution of 1.0 M Fe(NO₃)₃ was prepared by dissolving 171 g of Fe(NO₃)₃.9H₂O in 355 ml of deionized water. To this solution was added 2.0 g of HAuCl₄.3H₂O, which dissolved completely. A solution of 150 g of Na₂CO₃ in 1500 ml of deionized water was also prepared.

Both of the above solutions were added with stirring to 1500 ml of deionized water at 60° C. at such a rate as to maintain the pH at 8.0±0.2. The addition took about an hour and stirring was continued for an additional 0.5 hour after addition was complete. The suspension was allowed to cool to room temperature and filtered through a Buchner funnel. The solids were then re-slurried in 2500 ml of deionized water at room temperature for 0.25 hour and filtered using the Buchner funnel. This washing procedure was repeated three times and the solids then dried in an oven at 80° C. overnight. The very hard solids were then ground in a mortar and pestle and sieved through a 12, 14 and a 20 mesh screen. The particles that were collected on the 14 and 20 mesh screens were combined and placed in a porcelain crucible in an oven under a stream of air and calcined by ramping the temperature to 350° C. in 0.5 hour, then ramping to 400° C. in 0.25 hour and holding at 400° C. for an additional 0.5 hour.

### COMPARATIVE EXAMPLE 1A

### Sequential Precipitation

To 1500 ml of deionized water was added with stirring a solution of 400 ml of 1.0 M Fe(NO₃)₃ and a solution of 150 g of Na₂CO₃ in 1500 g of deionized water at such a rate that the pH of the solution was maintained at pH 8.0±0.2. The addition time was approximately 1.0 hours. An iron oxide precipitate was formed. The solution was then cooled with agitation to 60° C. and a solution of 2.0 g of HAuCl₄ in 150 ml of deionized water was then added along with additional Na₂CO₃ solution prepared as above at such a rate that the pH was maintained at 8.0±0.2. This addition took approximately 0.5 hour and the mixture was then stirred an additional 0.5 hours and then allowed to cool to room temperature. The washing and calcination procedures were the same as in Example 1. The yield of 14-20 mesh material in this case was 35%.

Testing—Procedure

The reactor used for testing was a 0.5-inch diameter by 12-inch length jacketed tube. Heat was supplied by fluid flowing through the jacket at temperatures between 70 and 75° C. A thermocouple was positioned so that it would sit in the middle of the catalyst bed. The catalyst was held in place by glass wool plugs.

A gas mixture of the following composition was used for all testing. H₂, 74%; CO₂, 18.8%; CO, 3300 ppm and the balance argon. Air was used as the source of oxygen. Both gasses were metered by precalibrated flow meters and mixed in a tee just before entering the reactor containing the catalyst. The exit gasses were flushed through a small Infra Red gas sampling cell for 2.0 hours before each measurement. The spectra were recorded on a Nicolet 210 FTIR spectrophotometer. Each sample was compared to a sample of the initial gas mixture before it was fed into the reactor.

### INVENTION EXAMPLE 2

### Use of the Catalyst of Invention Example 1

The reactor was charged with 9.0 ml of the catalyst prepared by coprecipitation in Example 1. An initial N₂ purge of the catalyst was done at about 2.0 L/hr, and heating fluid maintained between 70 and 75° C. was circulated through the reactor jacket. When the reactor thermocouple reached the same temperature as the circulating fluid, the N₂ was shut off and the CO containing gas mixture and air were introduced at 1700 and 400 ml/hr respectively, which is a gas hourly space velocity of 233 hr⁻¹. Initially there was water made and CO oxidation was not very efficient, but within 24 hours, water had stopped and CO conversion rose steadily. After an additional 16.0 hours the CO conversion had risen to better than 95%. In order to determine whether the catalyst was productive at higher space velocities, the flow of the CO gas mixture was increased to 9000 ml/hr and the airflow was increased to 2800 ml/hr, or a space velocity of 1311 hr⁻¹. The CO conversion was over 90%.

### COMPARATIVE EXAMPLE 2A

### Use of the Catalyst of Comp. Example. 2

The same procedure was used as in Invention Example 2 except that 14 ml of catalyst made by Comparative Example 2A was used. The same gas flows were also used so the space velocity in this example was 150 hr⁻¹. Water was again formed initially and stopped within 24 hours. After the water formation ceased the CO conversion increased steadily and after 16 hours was over 95%.

Contrary to the Plzak disclosure in German patent 198 36 585, it is clear from the above that the coprecipitation procedure is substantially equivalent to the sequential procedure when one follows my particular steps to obtain the desired size before calcining. The size I use, 0.85 to 3.25 mm, preferably 1-1.4 mm, is highly beneficial for commercial catalyst beds where pressure drop is a significant factor; my catalyst causes a far lower pressure drop than the powder used by Plzak. Plzak's powder is obtained at the end of his Example 2 by grinding. Unlike Plzak's precipitate, my dried precipitate is ground to a larger size, and I am able to do this before calcining.

My invention therefore is a method of oxidizing CO in a mixture of gases including oxygen and at least 65% hydrogen comprising passing the mixture of gases through a catalyst bed comprising a catalyst made by (a) preparing an aqueous iron/gold solution comprising an iron source and a gold source (b) gradually combining the iron/gold solution with an aqueous solution of an alkali metal base to maintain a pH of 7 to 9 in the combined solution as the solutions are combined, thereby producing solids in the combined solution (d) separating the solids from the combined solution (e) washing the solids, (f) drying the solids, (g) grinding the solids to a size range of 0.85 mm to 4.25 mm, and (h) calcining the solids. More particularly, the gas mixture treated may comprise 200 ppm to 20,000 ppm carbon monoxide and at least 10% carbon dioxide and, in most cases will be the product of a water gas shift reaction, containing methane and water as well. Oxygen should be added or otherwise present, preferably in a ratio of 1:1 to 10:1 of oxygen to carbon monoxide. As indicated above in the examples, the catalyst is initially activated by passing a gas in contact with it; the gas containing oxygen and hydrogen will make water for a short period of time.

1. Method of oxidizing CO in a mixture of gases including oxygen and at least 65% hydrogen comprising passing said mixture of gases through a catalyst bed comprising a catalyst made by (a) preparing an aqueous iron/gold solution comprising an iron source and a gold source (b) gradually combining said iron/gold solution with an aqueous solution of an alkali metal base to maintain a pH of 7 to 9 in the combined solution as the solutions are combined, thereby producing solids in said combined solution (d) separating said solids from said combined solution (e) washing said solids, (f) drying said solids, (g) grinding said solids to a size range of 0.85 mm to 4.25 mm, and (h) calcining said solids.

2. Method of claim 1 wherein said gold source comprises HAuCl₄.3H₂O.

3. Method of claim 1 wherein said iron source comprises Fe(NO₃)₃.9H₂O.

4. Method of claim 1 wherein step (b) is conducted at a temperature of 50° C. to 90° C.

5. Method of claim 1 wherein said pH is maintained at 7.5-8.5.

6. Method of claim 1 wherein said pH is maintained at 7.8-8.2.

7. Method of claim said gold is present in said catalyst as 0.25% to 10% by weight of said iron oxide.

8. Method of claim 7 wherein said gold is present in said catalyst as 1% to 3% by weight of said iron oxide.

9. Method of claim 1 wherein said alkali metal base is sodium carbonate.

10. Method of claim 1 wherein said mixture of gases comprises 200 ppm to 20,000 ppm carbon monoxide and at least 10% carbon dioxide.

11. Method of claim 1 wherein said catalyst has a size range of 1 mm to 1.4 mm.

12. Method of oxidizing CO in a mixture of gases including oxygen at least 65% hydrogen and wherein said CO is present in an amount from 200 ppm to 20,000 ppm, said gas also containing methane, comprising passing said mixture of gases through a catalyst bed comprising a particulate catalyst made by (a) preparing an aqueous iron/gold solution comprising an iron source and a gold source (b) gradually combining said iron/gold solution with an aqueous solution of an alkali metal base to maintain a pH of 7 to 9 in the combined solution as the solutions are combined, thereby producing solids in said combined solution (d) separating said solids from said combined solution (e) washing said solids, (f) drying said solids, (g) grinding said solids to a size range of 0.85 mm to 4.25 mm, and (h) calcining said solids, wherein the gold in said catalyst is present in an amount from 0.25% to 10% by weight of the iron in said catalyst.

13. Method of claim 12 wherein said gold is present as 1-3% of the weight of said iron.

14. Method of claim 1 wherein said catalyst is activated prior to use.

15. Method of claim 12 wherein said catalyst is activated prior to use.
